(19) United States
(12) Patent Application Publication
(10) Pub. No.: US 2024/0324690 A1
(43) Pub. Date: Oct. 3, 2024

(54) Non Thermal Aerosol Generating Device with Learning Mode

(71) Applicant: JT International SA, Geneva (CH)

(72) Inventors: Alec Wright, Guildford (GB); Damian Dickson, Ballymena (GB); Jaakko McEvoy, Vienna (AT); Tilen Ceglar, Vienna (AT)

(73) Assignee: JT International SA, Geneva (CH)

(21) Appl. No.: 18/609,808

(22) Filed: Mar. 19, 2024

(30) Foreign Application Priority Data
Mar. 29, 2023 (EP) EP23165021.9

(51) Int. Cl. A24F 40/51; A24F 40/05; A24F 40/10

(52) U.S. Cl. CPC A24F 40/51; A24F 40/05; A24F 40/10

(57) ABSTRACT

A non-thermal aerosol generating device includes: an aerosol generating liquid store, a mouthpiece, an aerosol generating unit: transforming the stored aerosol generating liquid into an aerosol, and ejecting the aerosol outside the mouthpiece. The non-thermal aerosol generating device has a first delivery mode, in which: the aerosol generating unit ejects the aerosol outside the mouthpiece at a first rate of aerosol collected mass, first rate being more than half the maximum rate. The non-thermal aerosol generating device also has: a second delivery mode, proposed or imposed to user at very first use of the aerosol generating device or available on user's demand, in which: the aerosol generating unit ejects the aerosol outside the mouthpiece at progressive rate of aerosol collected mass, starting at second rate, second rate being lower than first rate, progressing regularly from second rate toward first rate, reaching first rate, keeping on at first rate.

### FIELD OF THE INVENTION

The invention relates to the technical field of non-thermal aerosol generating devices.

### BACKGROUND OF THE INVENTION

Embodiments of the present invention relate to an acrosol generating device of the nebulizer type for producing inhalable droplets of a liquid on demand. More particularly, they relate to such aerosol generating device including preferably an air guiding means for allowing or promoting flow of produced liquid droplets to a vapor outlet.

There are existing several types and concepts for aerosol generating devices or inhalation devices that serve a broad range of purposes including medical and therapeutic applications as well as non-medical devices such as electronic cigarettes, cigalikes, vapor inhalers and related devices. Existing aerosol generating devices either vaporize a fluid before inhalation by delivering droplets of liquid at room temperature by, for example, employing an ultrasonic mesh.

Such aerosol generating devices or inhalation devices are oftentimes portable and handheld devices that can easily fit in the user's hand or can be handled by the user's fingers alone.

As noted above, some existing aerosol generating devices include an ultrasonic mesh powered by an electrical power source and a liquid reservoir containing flavored liquid that can be volatized using the ultrasonic mesh and transferred to a user of the aerosol generating device in an airflow, which is preferably guided through a mouthpiece of the device.

In case the aerosol is produced by using an ultrasonic mesh system, the aerosol is forcibly ejected from the device, in particular into the mouth of the user, which is unlike typical electronic cigarettes where a liquid aerosol precursor is heated to vaporization temperature to form the gaseous phase (vapor) to be inhaled upon user's inhalation to provide the needed airflow, which pulls the vapor into the mouth.

Aerosols generated by ultrasonic mesh systems usually comprise larger particle size than inhalable vapors generated by heating of aerosol precursors. Such larger particle size requires users to inhale sharply to ensure the aerosol penetrates sufficiently deep into the lungs. This leads to an increase of velocity of the vapor through the mouth of the user, hence, reduces the residence time in the mouth, which reduces and negatively impact the sensory experience of users, in particular the flavor perception and satisfaction.

Acrosol-generating devices relying on heating to vaporize liquids, require user inhalation to provide an airflow which pulls the vapor into user's mouth. So the inhalation rate influences the acrosol collected mass delivering rate into the mouth which contributes to the case of use of such devices for consumers.

In a non-thermal aerosol generating device, the aerosol is directly and forcibly ejected into user's mouth by the vapor generating unit. No user inhalation is specifically required for the vapor to reach the user's mouth cavity and a chosen aerosol collected mass can be delivered in the mouth cavity independent of a user's inhalation rate. However, as users naturally tend to inhale when using an aerosol-generating device, acrosol droplets may be inhaled too fast by users, generating reflex reactions such as coughing for instance.

For that reason, non-thermal aerosol generating devices, are often considered as more difficult and less pleasant to use than typical thermal aerosol generating devices.

There is thus a need to provide non-thermal aerosol generating devices with an improved, notably casier, user experience.

A first solution, which may be contemplated, would deal with a double structure within which two different ejection systems would be provided, one with a limited aerosol ejection rate for beginning users, the other one with a full aerosol ejection rate for experienced users. However, this first solution would be rather structurally complex and expensive, although rather easy to use.

A second solution, which may be contemplated, would deal with an ejection system controllable by user, so that user can choose the best rate and the best rate evolution over time dedicated to her or to him, and so that user can make this rate and this rate evolution over time change according to her or his gained vaporization experience.

According to a known first prior art, for example disclosed in patent application US2021/0260312, a system is provided with different dosages related to different users. This system can use predetermined patterns got from Artificial Intelligence. There can also be variations in delivery rates: either increasing or decreasing. There is even a mode where delivery rate starts from a minimum and increases, but only depending on air draw intensity by user.

In a nutshell, in this first prior art, there are proposed several types of variable rates, but there is proposed no real learning mode including any specific progressively increasing learning rate so as to make sure the user gets progressively used to this new aerosol generating device without being surprised or displeased with the use of this new aerosol generating device.

This first prior art merely tries to come back to the conditions of using a thermal aerosol generating device, to the cost of an haphazard and complex mechanism trying to adapt the generated aerosol delivery rate to the supposed wishes of the user expressed by the user's air draw intensity, rather than trying to teach this user how to use, in a pleasant and efficient way, this new specific non-thermal aerosol generating device.

According to a second prior art, for example disclosed in patent application WO2021105674, a system is provided with different aerosols with different densities. There can be variations in delivery rates: either increasing or decreasing.

There is a kind of mode which is adapted to the user, but it is rather the device learning from the user than the device teaching the user how to learn using this new specific non-thermal aerosol generating device.

### SUMMARY OF THE INVENTION

The object of the present invention is to alleviate at least partly the above mentioned drawbacks.

More particularly, the invention aims to help the user becoming gradually, but quickly, familiar with a non-thermal aerosol generating device, both:
by providing a learning mode for user at her or his very first use of the non-thermal aerosol generating device, more progressive than standard using mode,
and by not changing or practically not changing anything else in the standard using mode, having understood that it is only a question of user's habit, so keeping the standard using mode simple and efficient altogether,
and also without making too complex or too expensive structural changes, if any, within the aerosol generating device.

The invention proposes a specific learning mode dedicated to a non-thermal aerosol generating device and based on a progressively increasing generated aerosol delivering rate, starting from a low value, to give time to a beginning user to get used to it, and going toward the standard use value, to deliver sufficient amount of generated aerosol for an experienced user to fully enjoy it.

This object is achieved with a non-thermal aerosol generating device, comprising: an aerosol generating liquid store, a mouthpiece, an aerosol generating unit configured for: generating the stored aerosol generating liquid into an aerosol, and ejecting the aerosol outside the mouthpiece, the non-thermal aerosol generating device comprising a first delivery mode, in which: the aerosol generating unit ejects the aerosol outside the mouthpiece at a first rate of aerosol collected mass, first rate being more than half the maximum rate, wherein the non-thermal aerosol generating device also comprises: a second delivery mode, proposed or imposed to user at very first use of the aerosol generating device or available on user's demand, in which: the aerosol generating unit ejects the aerosol outside the mouthpiece at progressive rate of aerosol collected mass, starting at second rate, second rate being lower than first rate, progressing regularly from second rate toward first rate, reaching first rate, keeping on at first rate.

Indeed, in non-thermal aerosol generating devices, either there is no active heating or if there is any heating, this heating is not the main source of aerosol generation. The main source of aerosol generation is mechanical aerosol generation, which forms droplets of liquid through nebulization and not vaporization thereof. Heating can be used also in non-thermal aerosol generating device, but only to help the mechanical generation of aerosol, not to thermally generate vapor from liquid.

More generally speaking, this aerosol generating device could also be applied to any other type of non-thermal aerosol generating device. Another object of the invention is hence a non-thermal aerosol generating device, comprising two modes: a first mode, in which the aerosol is generated at a first rate, a second mode in which the aerosol is generated at a progressive rate, starting from a second rate lower than the first rate and progressively increasing toward the first rate.

Preferred embodiments comprise one or more of the following features, which can be taken separately or together, either in partial combination or in full combination, with any of previous objects of the invention.

The aerosol usually contains a flavor. This flavor can be tobacco. This flavor can be another flavor, such as a fruit or botanical flavor, or any other suitable flavor.

Preferably, in the second delivering learning mode: the aerosol generating unit ejects the aerosol outside the mouthpiece at a progressive rate of aerosol collected mass, progressing regularly from the second rate toward the first rate, during a number of user's puffs which is comprised between 5 puffs and 30 puffs, or between 10 puffs and 25 puffs, or between 15puffs and 25 puffs.

Hence, thanks to this specific range of puffs, not only is the duration of this specific learning mode both limited in time and efficient in use, but also it is somewhat better adapted to the specific user, being longer for slow users and shorter for quick users.

Preferably, the second rate is less than 20% of the first rate, or the second rate is about 10% of the first rate.

Hence, the second rate is sufficiently low so as to offer improved progressivity to the user along a broad range of rates.

Preferably, the first rate is more than 80% of the maximum rate, or the second rate is about 10% of the maximum rate.

Hence, the second rate is sufficiently low so as to offer improved progressivity to the user along a broad range of rates.

Preferably, in the second delivery mode, the aerosol generating unit ejects the aerosol outside the mouthpiece at a progressive rate of aerosol collected mass, keeping on at first rate, once first rate has been reached, during a number of user's puffs which is more than 5 puffs, or more than 10 puffs, or more than 20 puffs.

Hence, this specific learning mode not only progressively reaches the standard rate but also maintains this standard rate in a stable way for quite a notable amount of time in order to make sure that the user gets used not only to a high rate of forcing generated aerosol into her or his mouth, but also to make sure this user gets used to this standard rate itself.

Preferably, the non-thermal aerosol generating device comprises a puff sensor sensing the frequency and/or the duration and/or the intensity of user's puffs.

Hence, this is a simple component to measure accurately the subjective duration for a specific user, which is expressed not in seconds of time, but in number of puffs.

Preferably, the puff sensor adapts, as depending on the sensed frequency and/or sensed duration and/or sensed intensity of user's puffs, the number of user's puffs during which the aerosol generating unit progresses regularly from second rate toward first rate.

Hence, this learning mode not only teaches the user how to get used to this new type of non-thermal aerosol generating device, but also adapts to teach the user in a more personalized way.

Preferably, the puff sensor adapts, as depending on the sensed frequency and/or sensed duration and/or sensed intensity of user's puffs, the value of the reached first rate.

Hence, this learning mode not only teaches the user how to get used to this new type of non-thermal aerosol generating device, but also adapts to teach the user in a more personalized way.

Preferably, the puff sensor adapts, as depending on the sensed frequency and/or sensed duration and/or sensed intensity of user's puffs, the steepness variation of the progression from second rate toward first rate, via a feedback loop on the sensed frequency and/or sensed duration and/or sensed intensity of user's puffs.

Hence, this learning mode not only teaches the user how to get used to this new type of non-thermal aerosol generating device, but also adapts to teach the user in a more personalized way.

Preferably, the puffing sensor adapts, as depending on the sensed frequency and/or sensed duration and/or sensed intensity of user's puffs, during the second delivery mode, the value of the first rate during the first delivering using mode.

Hence, this learning mode not only teaches the user how to get used to this new type of non-thermal aerosol generating device, but also adapts the standard rate more personally to the specific user.

Preferably, in the second delivery mode, the aerosol generating unit ejects the aerosol outside the mouthpiece at a progressive rate of aerosol collected mass, progressing regularly from second rate toward first rate, following a straight ramp.

Hence, this type of progressive progression is a good compromise between the effectiveness and the simplicity of this specific learning mode.

Preferably, the second delivery mode is imposed to user at very first use of the aerosol generating device.

Hence, this makes sure that the first experience of the user is a good and pleasant one, avoiding the user to be taken by surprise.

Preferably, the second delivery mode is imposed to user only at very first use of the aerosol generating device, or the second delivery mode is activated only after the aerosol generating device has first exited a shipping mode.

Hence, this avoids bothering the user too long, especially if she or he is a quick learner. This also makes sure that the user is ready to use her or his new non-thermal aerosol generating device.

Preferably, the aerosol generating device aerosolizes the stored liquid by using a capillarity wick to bring the stored liquid to a perforated aerosol delivering element.

Hence, this is a good and simple way to eject generated aerosol into user's mouth.

Further features and advantages of the invention will appear from the following description of embodiments of the invention, given as non-limiting examples, with reference to the accompanying drawings listed hereunder.

### BRIEF DESCRIPTION OF THE DRAWINGS

FIG. 1 shows a schematic illustration of the general structure of an aerosol generation device in accordance with embodiments of the present invention.

FIG. 2 shows schematically a flowchart of the process undergone during the learning mode of the non-thermal aerosol generating device according to an embodiment of the invention.

FIG. 3 shows schematically the progressive evolution over time of the aerosol collected mass during the learning mode of the non-thermal aerosol generating device according to an embodiment of the invention.

### DETAILED DESCRIPTION OF THE INVENTION

Embodiments of the present disclosure will now be explained with reference to the drawings. It will be apparent to those skilled in the field of aerosol generating devices from this disclosure that the following description of the embodiments is provided for illustration only and not for the purpose of limiting the disclosure as defined by the appended claims. Features of the embodiments described below can also be used to further characterize the device defined in the claims.

Modifications of features can be combined to form further embodiments. Features described in individual embodiments can be provided in a single common embodiment if they are not incompatible. Likewise, features described in a single embodiment can be provided in several embodiments individually or in any suitable sub-combination.

As described hereinafter, example implementations of the present disclosure relate to an aerosol generating device or inhalation device. Electronic smoking devices or aerosol generating devices according to embodiments of the present invention use electrical energy to generate an inhalable aerosol, in particular liquid droplets.

In some example implementations, electronic smoking devices or aerosol generating devices within the meaning of the present invention may transport the volatilized particles in an airflow through the aerosol generating device to a user of the device, the user of the device being able to activate or deactivate the generation of aerosol and to control the duration, velocity and volume of the airflow by means of puffing or inhaling action.

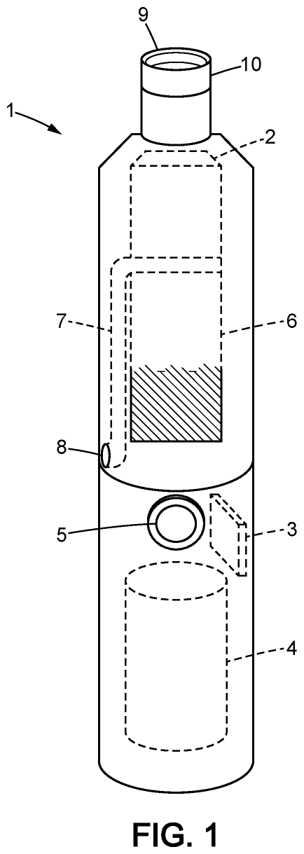

FIG. 1 shows a schematic illustration of the general structure of an aerosol generation device in accordance with embodiments of the present invention.

The aerosol generating device 1 comprises a liquid jet device 2 for producing droplets of a liquid on demand. The liquid jet device 2 comprises a fluid chamber, at least one ejection nozzle, a supply channel and a output element configured to output the liquid in order to cause ejection through the at least one ejection nozzle.

The term fluid chamber is meant to cover jet technologies generally, including at least piezo jet devices.

The aerosol generating device 1 further comprises a control unit 3 in accordance with an embodiment herein. Operation of the control unit 3 will be described in more detail below in relation to FIG. 1.

More generally, the control unit 3 may, as in the present example embodiment, be configured to control operation of the acrosol generation device 1. By way of example, such as the present example embodiment in which the aerosol generating device 1 comprises a power supply unit 4, the control unit 3 may control charging of the power supply unit. Additionally or alternatively, the control unit 3 may optionally control supply of power to, and receive and process signals from any sensors or I/O units (e.g. optional button 5) included in the aerosol generating device 1, and control operation of the aerosol generating device 1 based on the received signals.

The control unit 3 may comprise one or more processing units or modules (e.g. a central processing unit (CPU) such as a microprocessor, or a suitably programmed field programmable gate array (FPGA) or application-specific integrated circuit (ASIC)). Additionally or alternatively, the control unit 3 may be provided with any memory sections (not shown) necessary to perform its function of controlling operation of the aerosol generating device 1. Such memory sections may be provided as part of (comprised in) the control unit 3 (e.g. integrally formed or provided on the same chip) or provided separately, but electrically connected to the control unit 3. By way of example, the memory sections may comprise both volatile and non-volatile memory resources, including, for example, a working memory (e.g. a random access memory). In addition, the memory sections may include an instruction store (e.g. a ROM in the form of an electrically-erasable programmable read-only memory (EEPROM) or flash memory) storing a computer program comprising computer-readable instructions which, when executed by the control unit 3, cause the control unit 3 to perform various functions described herein.

The computer program comprising the computer-readable instructions which, when executed by the control unit 3, cause the control unit 3 to perform various functions described herein may, for example, be a software or a firmware program.

The aerosol generating device 1 may, as in the present example embodiment, further comprise a power supply unit 4. The power supply unit 4 may, as in the present example embodiment, be a rechargeable power supply. The power supply unit 4 may, as in the present example embodiment, be a lithium-ion battery. Alternatively, the power supply unit 4 may be, for example, a chargeable secondary battery or an electric double layer capacitor (EDLC) or any other suitable power supply means known in the art.

Additionally or alternatively, the aerosol generating device 1 may, as in the present example embodiment, comprise a reservoir 6 for storing an amount of said liquid to be vaporized. By way of non-limiting example, the liquid may contain nicotine and/or flavors (e.g. mint, menthol, herbs, tobacco particles, tobacco extract and/or fruit flavors). Optionally, the liquid stored in the reservoir 6 may include additional substances, such as glycerin, propylene glycol and/or water, to aid formation of an acrosol.

By way of example, the reservoir 6 and/or the liquid stored therein may be replaceable. By way of example, at least the reservoir 4 of the aerosol generating device 1 may be provided in the form of a replaceable cartridge.

Additionally or alternatively, the aerosol generating device 1 may, as the present example embodiment, comprise an air inlet 7 and a mixing chamber (not shown) in which air from said air inlet 7 is mixed with the liquid droplets generated by the liquid jet device 2. The air inlet 7 may further comprise at least one air inlet orifice 8 at some suitable site of said aerosol generating device 1.

Additionally or alternatively, the aerosol generating device 1 may, as in the present example embodiment, comprise a mouthpiece opening 9 through which a user may inhale the inhalation vapor. The mouthpiece 10 may be integral with the housing of the aerosol generating device 1, it may be replaceable, or may form part of a capsule or cartridge. The latter may comprise further elements, such as the mixing chamber, the liquid jet device 2 or the reservoir 4 so as to provide a replaceability of further elements for achieving convenience, flexibility, reliability and/or safety. Here also, any combination of elements is feasible.

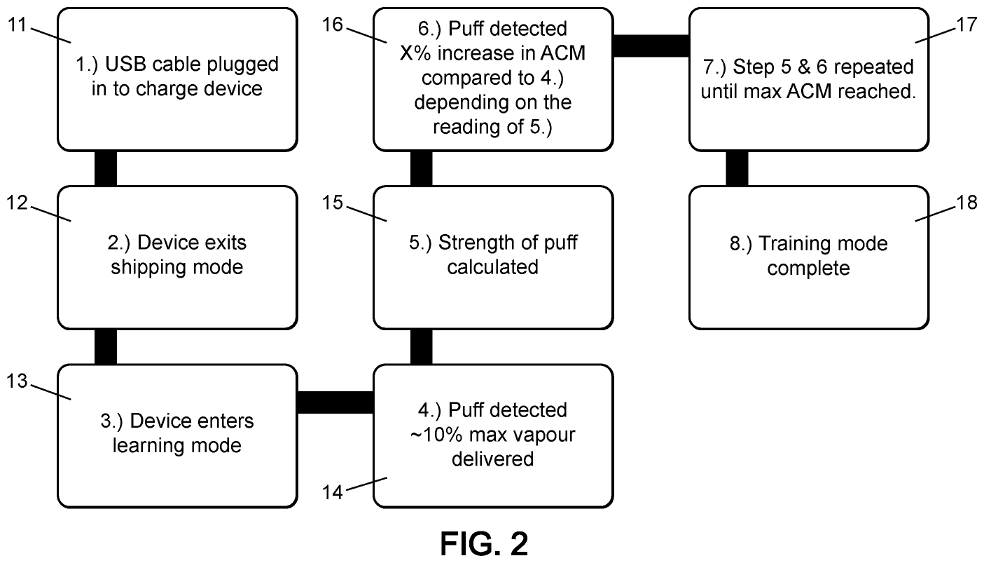

FIG. 2 shows schematically a flowchart of the process undergone during the learning mode of the non-thermal aerosol generating device according to an embodiment of the invention.

In a first step 11, the brand new non-thermal aerosol generating device is powered, for example by plugging its USB cable to a charging device.

In a second step 12, once this new non-thermal aerosol generating device has been powered, it exists the shipping mode (where it was completely inactive) in order to enter the use mode (where it becomes active).

In a third step 13, before entering the classical standard use mode, this new non-thermal acrosol generating device first enters the learning mode as provided for by an embodiment of this invention. There could be a supplementary specific OFF button (not shown on FIG. 1) included on the housing of this new non-thermal aerosol generating device, which by-passes the learning mode upon specific activation by the user, and which could be used by a user who just bought a new non-thermal aerosol generating device but who is however already an experienced user with this type of non-thermal aerosol generating device (having already experienced the learning mode when starting with her or his first non-thermal aerosol generating device of this kind).

In a fourth step 14, once entered into the learning mode, when the first user's puff is detected by the puff sensor included within the new non-thermal aerosol generating device, about 10% of maximal value of aerosol collected mass is delivered at first to the new user starting with the learning mode.

In a fifth step 15, which is fully optional, the puff sensor calculates the puff strength issued by the user. There can be alternatively no puff strength sensor detection in the learning mode.

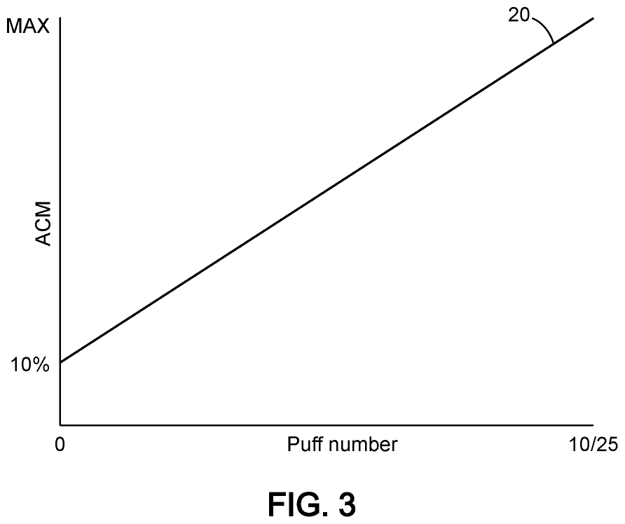

In a sixth step 16, the amount of delivered aerosol collected mass progressively increases all along the number of puffs issued by the user, rather regularly from 10% toward 100% of the maximal acrosol collected mass, either regularly following a straight ramp (as later described in FIG. 3) or depending on the user's puff strength measured by the puff sensor. In this latter case, the bigger the user's puff strength, the stiffer the ramp, and the smaller the user's puff strength, the smoother the ramp.

In a seventh step 17, the cycle made of former steps 15 and 16 are repeated, once or more times, until generated aerosol delivery into user's mouth reaches maximal aerosol collected mass.

In an eighth step 18, the training has been completed, the user exits the learning mode, and will enter the standard use mode, here at 100% of maximal aerosol collected mass, when further puffing, the switch from learning mode toward standard use mode being preferably direct and automatic, without transition, for continuity of the pleasure of puffing, for the user.

FIG. 3 shows schematically the progressive evolution over time of the aerosol collected mass during the learning mode of the non-thermal aerosol generating device according to an embodiment of the invention.

The aerosol collected mass ACM, is expressed in relative value, that is in percentage (%), from 0 (no generated aerosol delivery into user's mouth) to the maximum noted MAX on FIG. 3 and corresponding to maximum possible delivery of generated aerosol into user's mouth and here also to full delivery of generated aerosol into user's mouth both during the learning mode of the non-thermal aerosol generating device and during the standard use mode of the non-thermal aerosol generating device.

This aerosol collected mass is expressed as a function of subjective or relative time dedicated to the user, so expressed in number of user's puffs, the total number of user's puffs during the learning mode usually ranging from 10 to 25. Even if number of user's puffs is a subjective time, it is related to objective time computed in seconds, since, for a given user, the highest the number of user's puffs, the longer the time in seconds.

This amount of aerosol collected mass is represented by a curve 20, which here is preferably a straight ramp over the time interval starting at 0 at beginning of learning mode and reaching the total number of user's puffs (itself comprised between 10 and 25 user's puffs) at end of learning mode, this straight ramp starting at about 10% of the maximal aerosol collected mass at beginning of learning mode and reaching about 100% of the maximal aerosol collected mass at end of learning mode.

The invention has been described with reference to preferred embodiments. However, many variations are possible within the scope of the invention.

1. A non-thermal aerosol generating device, comprising:
an aerosol generating liquid store,
a mouthpiece,
an aerosol generating unit configured for:
generating the stored aerosol generating liquid into an aerosol, and
ejecting the aerosol outside the mouthpiece (10),
the non-thermal aerosol generating device comprising a first delivery mode, in which:
the aerosol generating unit is configured to eject the aerosol outside the mouthpiece at a first rate of aerosol collected mass,
first rate being more than half a maximum rate, wherein the non-thermal aerosol generating device further comprises:
a second delivery mode, in which:
the aerosol generating unit is configured to eject the aerosol outside the mouthpiece at a progressive rate of aerosol collected mass,
starting at second rate, second rate being lower than first rate,
progressing regularly from second rate toward first rate,
reaching first rate,
keeping on at first rate.

2. The non-thermal aerosol generating device, comprising two modes:
a first mode, in which the aerosol is generated at a first rate, and
a second mode in which the aerosol is generated at a progressive rate, starting from a second rate lower than the first rate and progressively increasing toward the first rate.

3. The non-thermal aerosol generating device according to claim 1, wherein:
in the second delivery mode:
the aerosol generating unit is configured to eject the aerosol outside the mouthpiece at progressive rate of aerosol collected mass,
progressing regularly from second rate toward first rate,
during a number of user's puffs which:
is comprised between 5 puffs and 30 puffs.

4. The non-thermal aerosol generating device according to claim 1, wherein:
the second rate is less than 20% of the first rate,
or the second rate is about 10% of the first rate.

5. The non-thermal aerosol generating device according to claim 1, wherein:
the first rate is more than 80% of the maximum rate,
or the second rate is about 10% of the maximum rate.

6. The non-thermal aerosol generating device according to claim 1, wherein:
in the second delivery mode:
the aerosol generating unit is configured to eject the aerosol outside the mouthpiece at progressive rate of aerosol collected mass,
keeping on at first rate, once first rate has been reached, during a number of user's puffs which:
is more than 5 puffs.

7. The non-thermal aerosol generating device according to claim 1, wherein the non-thermal aerosol generating device further comprises a puff sensor sensing the frequency and/or the duration and/or the intensity of user's puffs.

8. The non-thermal aerosol generating device according to claim 7, wherein:
the puff sensor is configured to adapt,
as depending on the sensed frequency and/or sensed duration and/or sensed intensity of user's puffs,
the number of user's puffs during which the aerosol generating unit progresses regularly from second rate toward first rate.

9. The non-thermal aerosol generating device according to claim 7, wherein:
the puff sensor is configured to adapt,
as depending on the sensed frequency and/or sensed duration and/or sensed intensity of user's puffs,
the value of the reached first rate.

10. The non-thermal aerosol generating device according to claim 7, wherein:
the puff sensor is configured to adapt,
as depending on the sensed frequency and/or sensed duration and/or sensed intensity of user's puffs,
the steepness variation of the progression from second rate toward first rate, via a feedback loop on the sensed frequency and/or sensed duration and/or sensed intensity of user's puffs.

11. The non-thermal aerosol generating device according to claim 7, wherein:
the puffing sensor is configured to adapt,
as depending on the sensed frequency and/or sensed duration and/or sensed intensity of user's puffs, during the second delivering learning mode,
the value of the first rate during the first delivering using mode.

12. The non-thermal aerosol generating device according to claim 1, wherein:
in the second delivery mode:
the aerosol generating unit is configured to eject the aerosol outside the mouthpiece at progressive rate of aerosol collected mass,
progressing regularly from second rate toward first rate, following a straight ramp.

13. The non-thermal aerosol generating device according to claim 1, wherein the second delivery mode is imposed to user at very first use of the aerosol generating device.

14. The non-thermal aerosol generating device according to claim 1, wherein:
the second delivery mode is imposed to user only at very first use of the aerosol generating device,
or the second delivery mode is activated only after the aerosol generating device has first exited a shipping mode.

15. The non-thermal aerosol generating device according to claim 1, wherein the aerosol generating device is configured to aerosolize the stored liquid by using a capillarity wick to bring the stored liquid to a perforated aerosol delivering element.
